(19) United States
(12) Patent Application Publication
(10) Pub. No.: US 2007/0066137 A1
(43) Pub. Date: Mar. 22, 2007

(54) AN IMPROVED STRUCTURE OF PLUG MODULE BASE

(75) Inventor: Haven Yang, Taipei County (TW)

Correspondence Address: HAVEN YANG, Apt. 3D, 3620 168th St., Flushing, NY, 11358, US

(73) Assignee: All Best Electronics Co., Ltd.

(21) Appl. No.: 11/227,864

(22) Filed: Sep. 16, 2005

(51) Int. Cl. H01R 13/648

(52) U.S. Cl. 439/607

(57) ABSTRACT

An improving structure of electrical plug set comprises a top plate, one end of the top plate has a rear plate that can be folded perpendicularly, and one foldable protruding part is formed at each side of the rear plate. A fixing opening is formed on each foldable protruding part. The improving structure further comprises a first side plate and second side plate, wherein at least one flexible positioning plate that is formed on one end of the first side plate and the second side plate is integrated with the rear plate by inserting the flexible positioning plate into the fixing opening of the foldable protruding part of the rear plate. A plurality positioning legs of the first side plate are passed through openings of an outer foldable plate and are integrated respectively to positioning slots of the flexible locating plates.

### BACKGROUND OF THE INVENTION

1. Field of Invention

The present invention relates generally to an improving structure of electrical plug set. More particularly, the present invention relates to an improving structure of the plug set that is simple to assemble, and the cost of the fabrication is low which can improve its product's competition ability in the current market.

2. Description of the Related Art

FIG. 1 shows a conventional electrical plug set, a top plate 71 is connected to the two side plates 72, a bottom plate 73 is bent to form a cross-sectional area of structure 7. One end of the structure 7 comprises a cover plate 74 bending to cover up the structure 7. An opening 76, which is formed at another end of the structure 7 is utilized to locating the plug set. A connecting gap is formed in between the one side of one of plates 72 and the bottom plate 73 of the structure 7. A foldable outer plate 75 is formed at middle part of the bottom plate 73 in order to support the side plates 72. A smaller foldable plate 731 is arced upwards at one side of the foldable outer plate 75. A hole is formed on the side plates 72 to integrate the foldable plate 731. Finally, a rear plate 74 is connected to the side plates 72, and outer edges of the foldable outer plate 75 are connected to the side plates 72. The smaller foldable plate 731 is assembled to the hole. The connection of this conventional structure is achieved by welding the components together, such as the welded parts 741, 751, 732. The welding is necessary to assembly the rear plate 74, the outer foldable plate 75, the smaller foldable plate 731 and the structure 7 to form a stable assembled structure.

However, the welding method of the conventional structure is clearly required time and the cost of the fabrication is also increased. Thus, the product's competition ability in the market is thus affected

### SUMMARY OF THE INVENTION

It is an object of the present invention to provide an improving structure of electrical plug set that is sample to integrated and is stable. The improving structure of electrical plug set of the present invention comprises a top plate, a first side plate, a second side plate, a rear plate, a bottom plate and an outer foldable plat. One end of the top plate has a rear plate that can be folded perpendicularly, and one foldable protruding part is formed at each side of the rear plate. A fixing opening is formed on each foldable protruding part. The improving structure further comprises a first side plate and second side plate, wherein at least one flexible positioning plate that is formed on one end of the first side plate and the second side plate is integrated with the rear plate by inserting the flexible positioning plate into the fixing opening of the foldable protruding part of the rear plate. A plurality positioning legs of the first side plate are passed through openings of an outer foldable plate and are integrated respectively to positioning slots of the flexible locating plates.

It is another object of the present invention to provide an improving structure of electrical plug set that is low cost to fabricated.

It is another object of the present invention to provide an improving design that the electrical plug set comprises simple and few components to assembly, and once all the components are integrated together, the improving structure is stable and strong.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is a 3-D view of a structure of conventional electrical plug set.

FIG. 2 is a cross-sectional view of an improving structure of electrical plug set in accordance with a preferred example of the present invention.

FIG. 3 is a 3-D assembled view of an improving structure of electrical plug set in accordance with a preferred example of the present invention.

FIG. 4 is a right-hand view of the assembled structure of electrical plug set of the present invention shown in FIG. 3.

FIG. 5 is a left-hand view of the assembled structure of electrical plug set of the present invention shown in FIG. 3.

FIG. 6 is a perspective view of one of the practical examples utilizing the improving structure of electrical plug set of the present invention.

### DESCRIPTION OF THE PREFERRED EMBODIMENTS

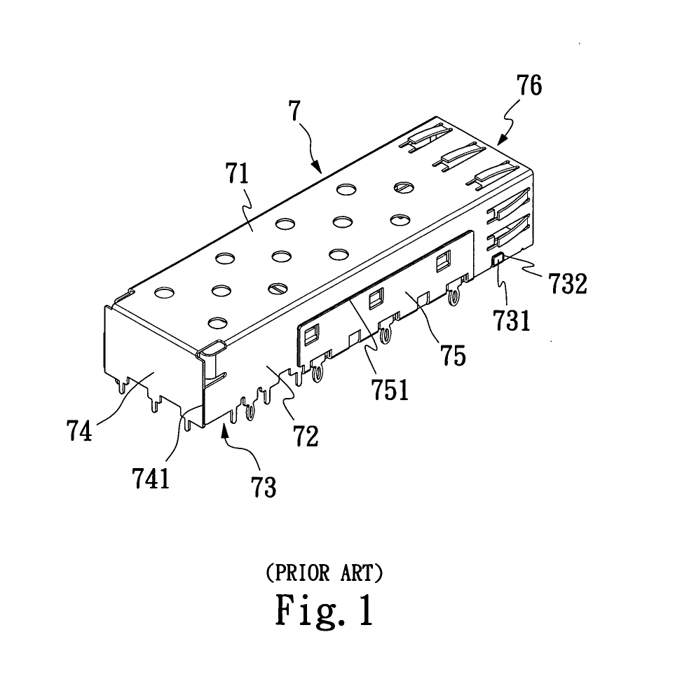

FIG. 1 illustrates a 3-D view of a structure of conventional electrical plug set. From the above-mentioned, the defects induced by the conventional design of electrical plug set are the main objectives of the present invention to provide an improving design that can overcome those defaults.

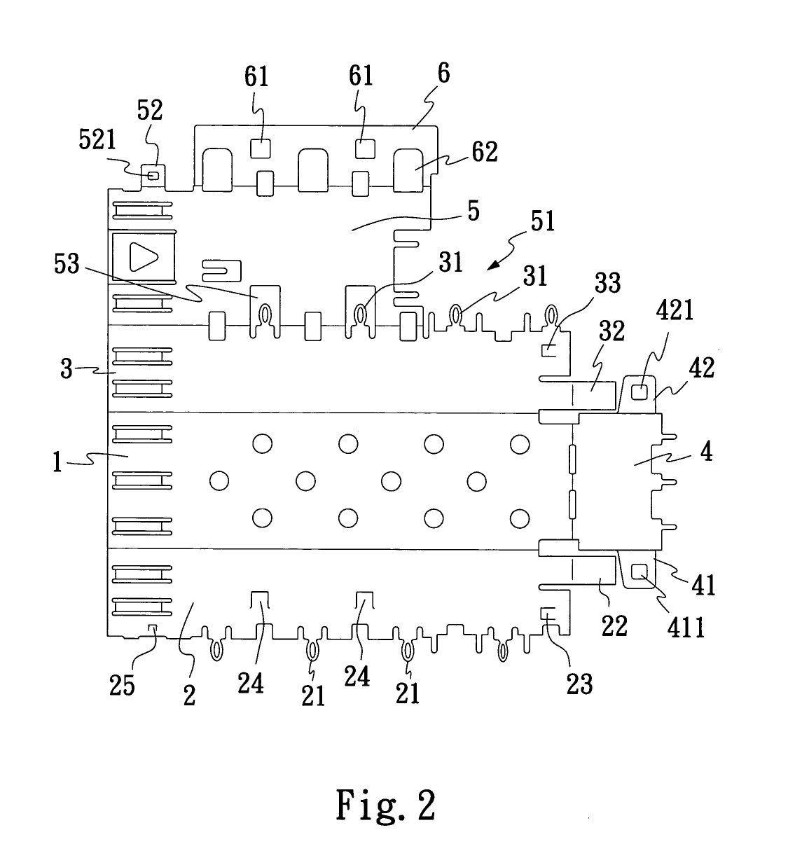

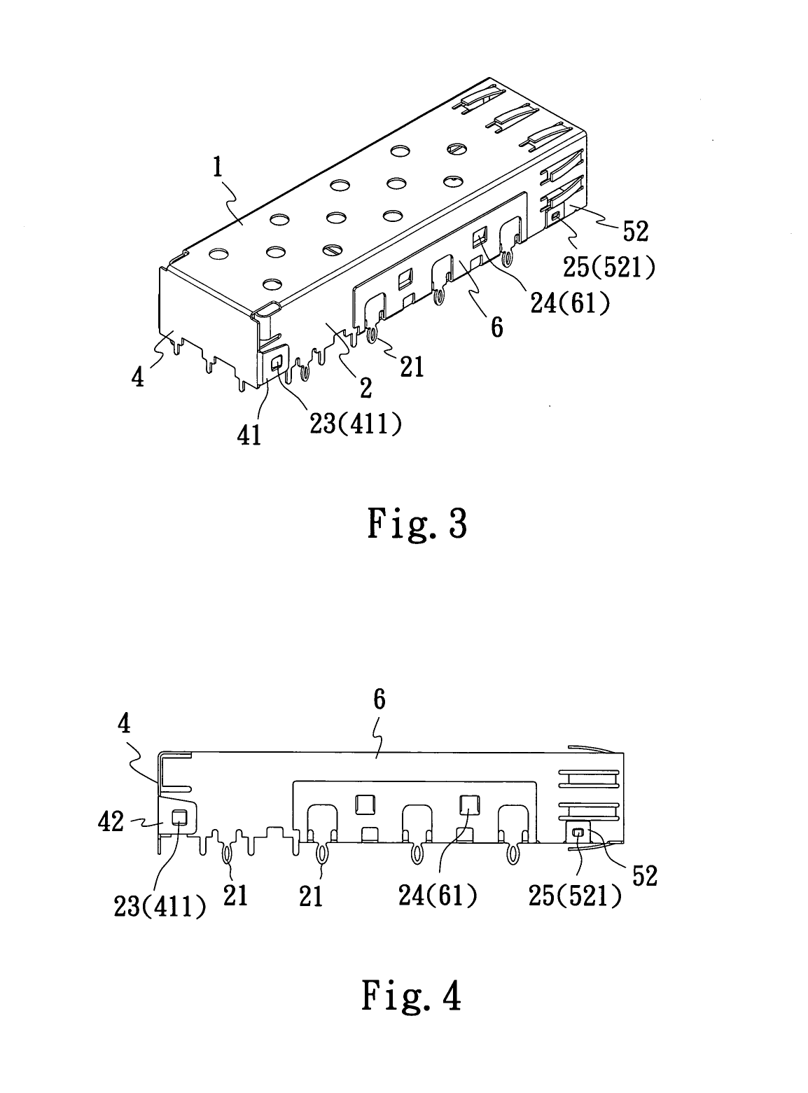

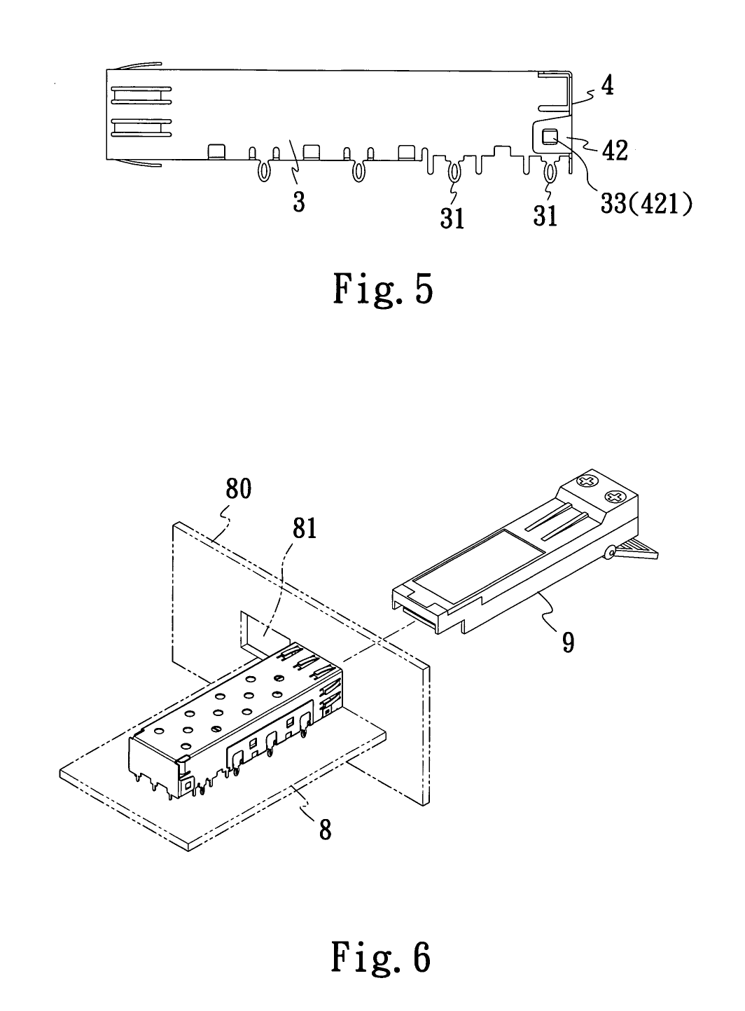

FIG. 2 is a cross-sectional view of an improving structure of electrical plug set in accordance with a preferred example of the present invention. Refer to other drawings, FIGS. 3, 4 and 5, it is clear that the present invention provides an improving structure of electrical plug set comprising a top plate 1, a first side plate 2, a second side plate 3, a rear plate 4, a bottom plate 5 and an outer foldable plate 6. One end of the rear plate 4 is connected to the one side of the top plate 1, and foldable protruding parts 41, 42 which are formed respectively on each side of the rear plate 4 can be folded up perpendicularly.

Fixing openings 411, 421 are formed respectively on the foldable protruding parts 41 and 42. The first side plate 2 and the second side plate 3 are connected respectively to both sides of the top plate 1, wherein the a plurality of positioning legs 21, 31 are protruded from outer edges of the both side plates 2 and 3. The first side plate 2 and the second side plate 3 are assembled to the top cover 1, at least one flexible positioning plate 23 or 33 is extended and arced slightly from each end of the rear plate 4 so that it can be inserted into the foldable protruding parts 41 and 42 of the fixing openings 411 and 421. Refer to FIG. 2, foldable inner portions 22, 32 are protruded respectively at each side of the flexible positioning plate 23 of the first side plate 2 and the flexible positioning plate 33 of the second side plate 3 for supporting the both inner sides of the rear plate 4 in order to prevent the rear plate 4 from bending inwards.

At least one flexible positioning plate 25 is formed and arced slightly at an angle from one end of the first side plate 2. A plurality of flexible locating plates 24 are formed slightly at an angle from a middle part of the flexible positioning plate 23. One end of bottom plate 5 is connected to the second side plate 3 and another end of the bottom plate 5 is connected to the outer foldable plate 6. A trench 51 is formed on one side of the bottom plate 5, and a foldable portion 52, which is protruded in the same direction as the outer foldable plate 6 is formed on another side of the bottom plate 5. A fixing slot 521 is formed on the foldable portion 52 and is correspondingly to the flexible positioning plate 25 of the first side plate 2.

A plurality of holes 53 are formed on one side of a connection between the bottom plate 5 and the second side plate 3, wherein the holes 53 are utilized to locate correspondingly the positioning legs 31 of the second side plate 3. A plurality of positioning slots 61, which are formed on a middle portion of the outer foldable plate 6 are correspondingly to the flexible locating plates 24 of the first side plate 2. A plurality of openings 62 are formed on one side of a connection between the outer foldable plate 6 and the bottom plate 5. In integrating, the outer foldable plate 6 is folded outwards to cover the middle side area of the first side plate 2 as shown in FIG. 3. The positioning legs 21 of the first side plate 2 are passed through the openings 62 of the outer foldable plate 6 and are integrated respectively to the positioning slots 61 of the flexible locating plates 24. A protecting wall is formed by integrating the outer foldable plate 6 onto the first side plate 2, and in combination with the flexible positioning plate 25 is integrated into the fixing slot 251. Thus, a simple and stable improving structure of electrical plug set is formed.

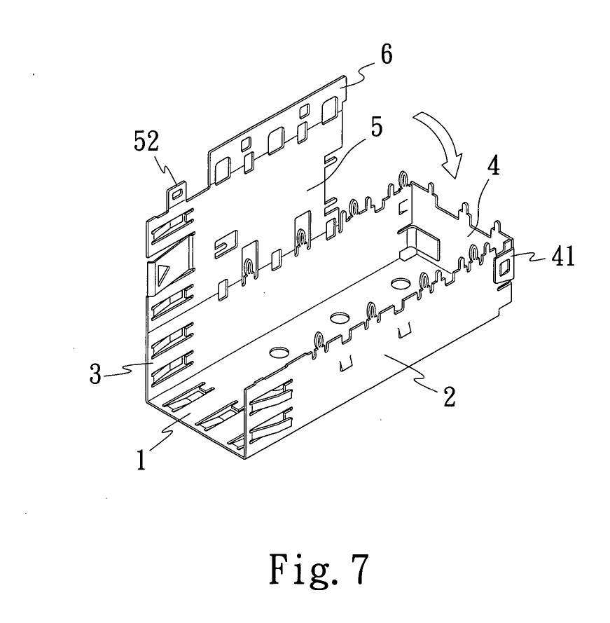

FIG. 6 shows a perspective view of one of the practical examples utilizing the improving structure of electrical plug set of the present invention. Once the top plate 1, the first side plate 2, the second side plate 3 and the bottom plate 5 are assembled together to form a square-shaped structure and the rear plate 4 is utilized to cover a back side of the square-shaped structure so that an opening is formed at a front section of the square-shaped structure. The positioning legs 21 and 31 are inserted into pre-set holes formed on the top section of an electrical circuit board 8. The devices located inside the structure can utilize the trench 51 of the bottom plate 5 to connect to a pre-set plug opening 81 on a board 80. An outer connecting plug set 9 is connected to the electrical circuit board 8 through the pre-set plug opening 81.

From the above-mentioned preferred examples, the present invention provides an improving structure of electrical plug set that is simple to assembled and low cost of manufacturing so that the improving product competes better in the market with other designs of plug sets.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. An improved structure of plug module base, comprising:
a top plate;
a rear plate, connecting to one end of the top plate, wherein the rear plate can be folded perpendicularly to the end of the top plate, and one foldable protruding part is formed at each side of the rear plate, a fixing opening is formed on each foldable protruding part;
a first side plate, connecting to one side of the top plate, wherein the first side plate can be folded perpendicularly towards the rear plate, at least one flexible positioning plate that is formed on one end of the first side plate is integrated with the rear plate by inserting the flexible positioning plate into the fixing opening of the foldable protruding part of the rear plate, and a plurality of flexible locating plates are formed at a middle portion of the first side plate;
a second side plate, connecting to the another side of the top plate, wherein the second side plate can be folded perpendicularly towards the rear plate, at least one flexible positioning plate that is formed on one ed of the second side plate is integrated with the rear plate by inserting the flexible positioning plate into the fixing opening of the foldable protruding part of the rear plate;
a bottom plate, connecting to one side of the top plate and the second side plate, wherein the bottom plate can be folded perpendicularly towards the first side plate; and
an outer foldable plate, connecting to one side being opposite to the second side plate of the bottom plate, wherein the outer foldable plate can be folded perpendicularly towards the top plate, a plurality of the fixing openings are formed correspondingly to the flexible positioning plate of the first side plate, the flexible positioning plate is integrated into the fixing openings of the outer foldable plate to form a protecting wall outside of the first side plate.

2. The improved structure of claim 1, wherein a foldable protruding part is formed and protruded from one end of the first side plate, a fixing opening is formed on the foldable protruding part, a flexible positioning plate is formed correspondingly to the fixing opening so that the flexible positioning plate can be integrated into the fixing opening.

3. The improved structure of claim 2, wherein at least one positioning leg is formed and protruded from the one side of the first side plate and the second side plate.

4. The improved structure of claim 3, wherein a plurality of holes are formed at one side of a connection between the bottom plate and the second side plate.

5. The improved structure of claim 4, wherein at least one foldable inner portion is formed and protruded respectively at each side of the flexible positioning plate of the first side plate and the flexible positioning plate of the second side plate for supporting both inner parts of the rear plate in order to prevent the rear plate from bending inwards.
